(19) United States
(12) Patent Application Publication
(10) Pub. No.: US 2021/0199182 A1
(43) Pub. Date: Jul. 1, 2021

(54) DEVICE FOR ADJUSTING TAUTNESS OF MOTOR BELT OF TABLE SAW

(71) Applicant: Chin-Chin Chang, Taichung City (TW)

(72) Inventor: Chin-Chin Chang, Taichung City (TW)

(21) Appl. No.: 16/726,893

(22) Filed: Dec. 25, 2019

(51) Int. Cl. F16H 7/14; B23D 47/12

(52) U.S. Cl. CPC F16H 7/14; B23D 45/06; B23D 47/12

(57) ABSTRACT

A device for adjusting tautness of a belt of a motor of a table saw is provided with an adjustment screw, and a pivot. In response to unfastening the adjustment screw, the motor counterclockwise rotates about the pivot to tighten the belt until predetermined tautness is obtained. The adjustment screw fastens to keep the belt at the predetermined tautness. Alternatively, the motor clockwise rotates about the pivot to loosen the belt.

### BACKGROUND OF THE INVENTION

### 1. Field of the Invention

The invention relates to table saws and more particularly to a table saw having a device for adjusting tautness of a belt of a motor.

### 2. Description of Related Art

Belt of a motor of a table saw may become loose after a period of time of operation. It is typical that an employee may adjust tautness of the belt. However, as shown in FIG. 1, there is no device for adjusting tautness of a belt of a motor of a conventional table saw.

U.S. Pat. No. 9,186,734 to Chang, entitled “height adjustment mechanism of table saw”, discloses a support including a concave seat, two first sleeves spaced from both ends of the seat respectively, a guiding hole, and two parallel brackets spaced from the guiding hole; a drive rod rotatably extended through the brackets; a first bevel gear mounted to an open end of the drive rod; first and second guide uprights fastened in the first sleeves respectively; a threaded guide rod inserted through the guiding hole; a second bevel gear at a bottom end of the guide rod to mesh with the first bevel gear; a motor including a threaded guide hole secured to the guide rod, two second sleeves with the first and second guide uprights sliding through respectively; and two support elements each including a concave base member, a sliding rail on the base member, and a fastening member.

While the '734 patent enjoys its success in the market, it is only directed to adjust a cutting height of the blade with no provision of adjusting cutting tension. Thus, continuing improvements in the exploitation of cutting tension adjustment are constantly being sought.

### SUMMARY OF THE INVENTION

It is therefore one object of the invention to provide a table saw comprising an upper cutting surface; a circular saw blade adjustably disposed through the upper cutting surface; a height adjustment mechanism including a drive rod, a bevel gear assembly, a guide rod and a mount; and a motor including a motor shaft, an upper bracket having an oval slot at one side, an adjustment screw driven through the oval slot into the mount of the height adjustment mechanism, a pivot at the other side with the mount of the height adjustment mechanism pivotably secured thereto, and a belt linking the motor shaft and a rotating shaft adjacent to the mount; wherein in response to rotating the height adjustment mechanism, the drive rod turns and the bevel gear assembly activates to rotate the guide rod; the rotation of the guide rod is stopped when the motor is lowered to a position under the upper cutting surface to create a space between the motor and the upper cutting surface; and in response to unfastening the adjustment screw, the motor is configured to counterclockwise pivot about the pivot until the belt has predetermined tautness.

The above and other objects, features and advantages of the invention will become apparent from the following detailed description taken with the accompanying drawings.

### BRIEF DESCRIPTION OF THE DRAWINGS

FIG. 1 is a perspective view of a conventional motor of a table saw;

FIG. 2 is a perspective view of a table saw according to the invention;

FIG. 3 is an exploded perspective view of a table saw incorporating the motor and the device;

FIG. 4 is a perspective view of the motor and related components;

FIG. 5 is an exploded view of FIG. 4;

FIG. 6 is a perspective view of a motor and a device for adjusting tautness of a belt of the motor according to the invention;

FIG. 7A is a side elevation of the motor;

FIG. 7B is a view similar to FIG. 7A showing an adjustment of tautness of the belt by counterclockwise pivoting the motor;

FIG. 8 is a perspective view of the table saw showing the motor being lowered; and

FIG. 9 is a detailed view of the area in a rectangle A of FIG. 8;

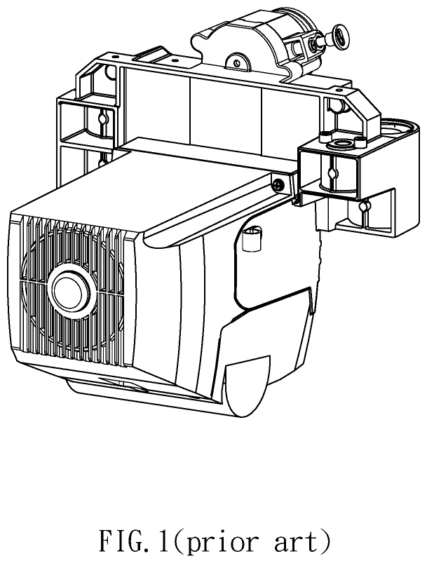

### DETAILED DESCRIPTION OF THE INVENTION

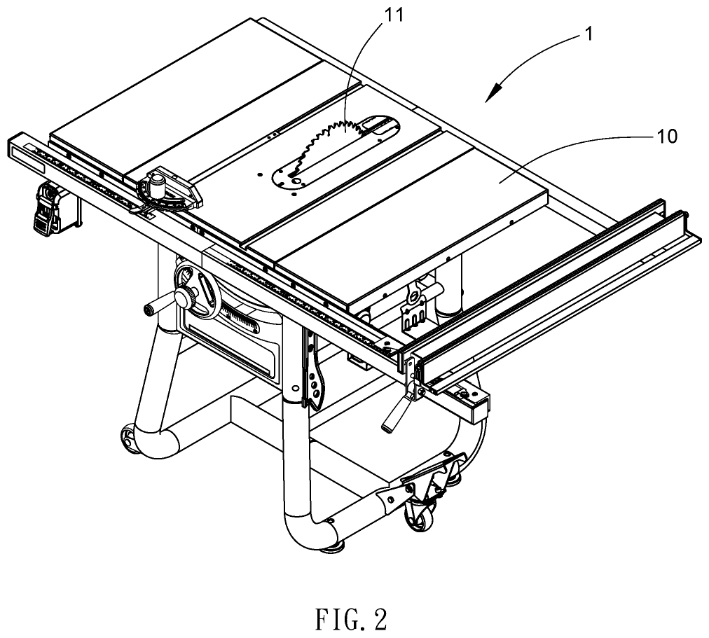

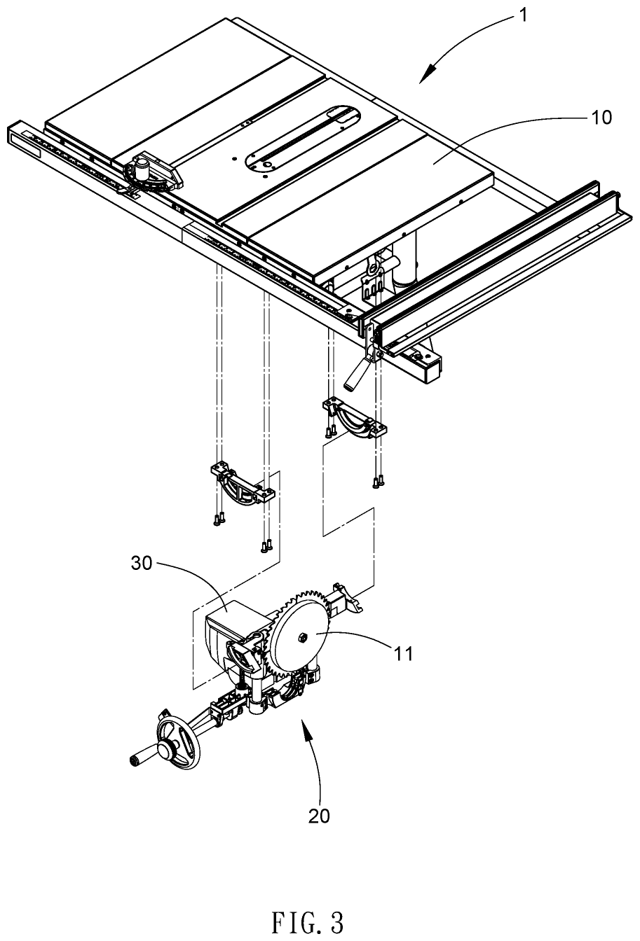

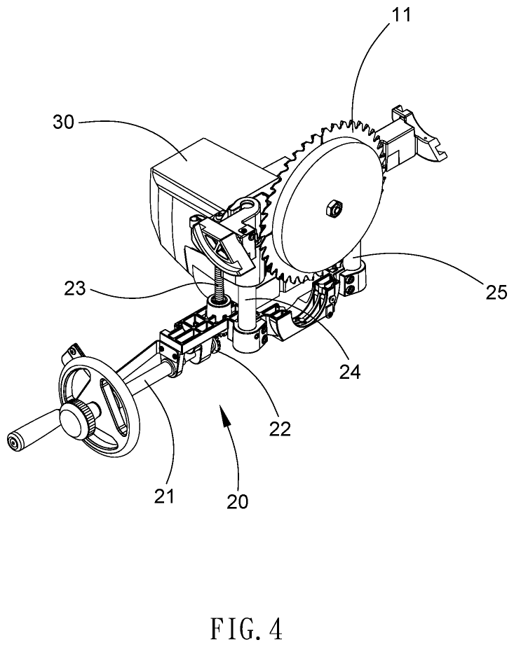

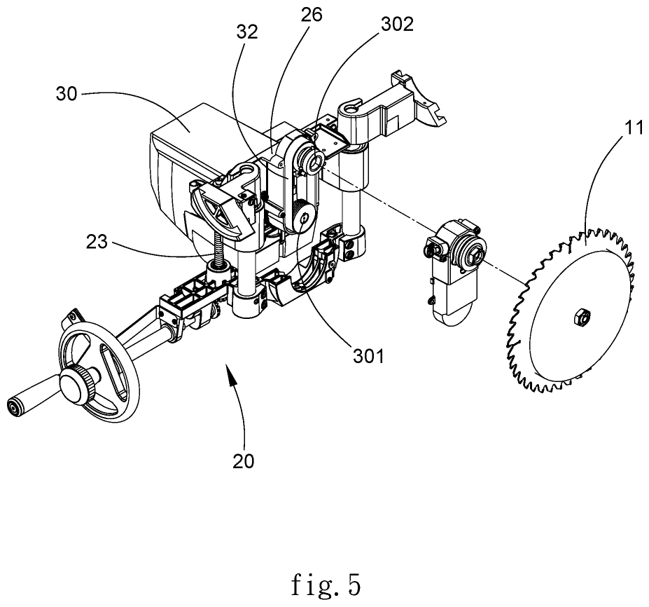

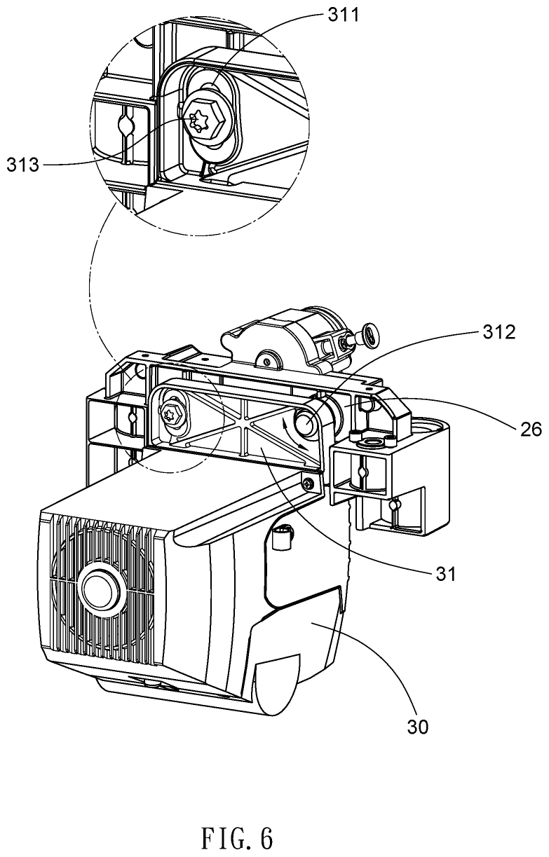

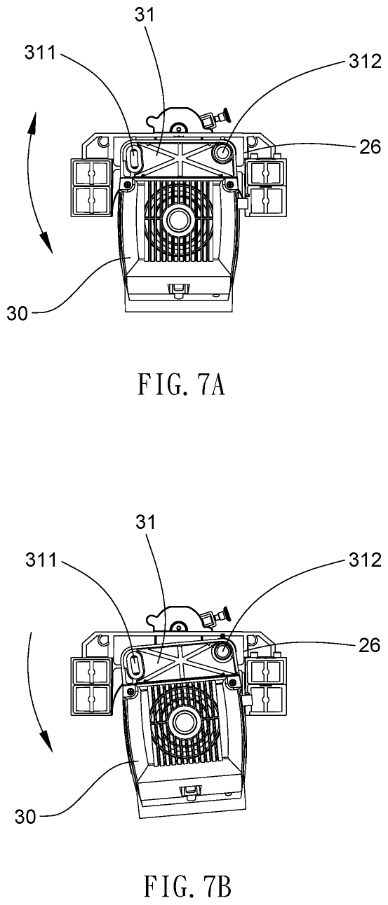

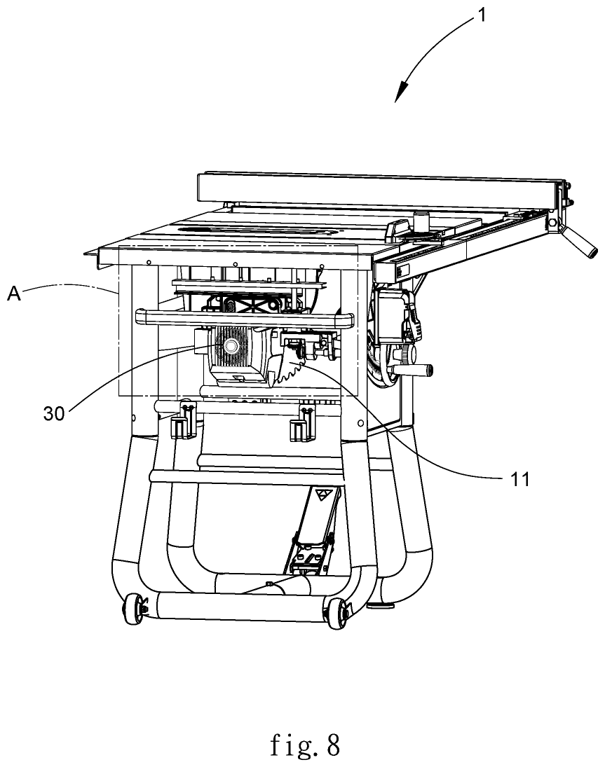

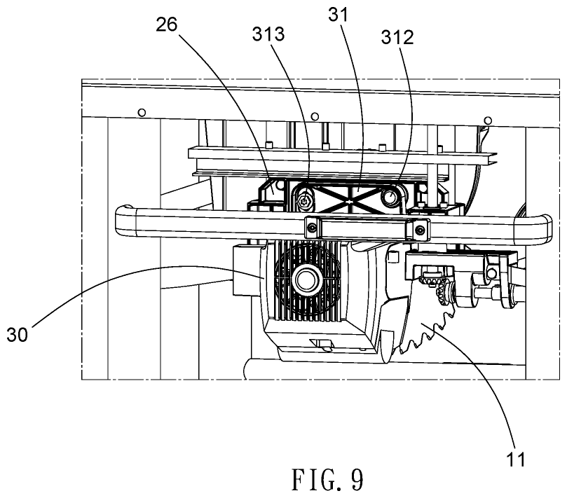

Referring to FIGS. 2 to 9, a table saw 1 in accordance with the invention comprises an upper cutting surface 10 including a circular saw blade 11, a height adjustment mechanism 20 including an upper mount 26, and a motor 30 including an upper bracket 31 having an oval slot 311 at one side, an adjustment screw 313 driven through the oval slot 311 into the mount 26 of the height adjustment mechanism 20, and a pivot 312 at the other side with the mount 26 of the height adjustment mechanism 20 pivotably secured thereto. In short, the upper bracket 31 of the motor 30 is adjustably disposed in the mount 26 of the height adjustment mechanism 20 by means of both the adjustment screw 313 and the pivot 312, thereby adjusting a position of a motor shaft 301 of the motor 30.

A device for adjusting tautness of a belt 32 of the motor 30 of the table saw 1 as the subject of the invention as discussed in detail below.

An employee may rotate the height adjustment mechanism 20 to turn a drive rod 21. And in turn, a bevel gear assembly 22 activates to rotate a guide rod 23. And in turn, the guide rod 23 pushes the mount 26 upward to move along a first guide upright 24 and a second guide upright 25. Regarding adjusting tautness of the belt 32 of the motor 30, the rotation of the guide rod 23 is stopped when the motor 30 and the circular saw blade 11 are lowered to an appropriate position under the upper cutting surface 10. At this position, a sufficient space between the motor 30 and the upper cutting surface 10 is created. Next, an employee may put an open end wrench (e.g., T40) or a socket wrench (e.g., ½″ socket wrench) on the adjustment screw 313 to unfasten the adjustment screw 313. Therefore, the motor 30 is configured to counterclockwise pivot about the pivot 312 until the loosened belt 32 linking the motor shaft 301 of the motor 30 and a rotating shaft 302 adjacent to the mount 26 becomes taut as desired. The circular saw blade 11 is operatively connected to the rotating shaft 302. Alternatively, the motor 30 is configured to clockwise pivot about the pivot 312 until the excessively taut belt 32 becomes appropriately taut as desired. Next, the employee may use the wrench to fasten the adjustment screw 313 to finish the tautness adjustment of the belt 32.

It is envisaged by the invention that the adjustment is very easy and effective.

While the invention has been described in terms of preferred embodiments, those skilled in the art will recognize that the invention can be practiced with modifications within the spirit and scope of the appended claims.

1. A table saw, comprising:
first and second guide uprights;
an upper cutting surface;
a circular saw blade adjustably disposed through the upper cutting surface;
a height adjustment mechanism including a drive rod, a bevel gear assembly, a guide rod, and a mount; and
a motor including a motor shaft, an upper bracket having an oval slot at one side, an adjustment screw driven through the oval slot into the mount, a pivot at the other side with the mount pivotabiy secured thereto, and a belt linking the motor shaft and a rotating shaft adjacent to the mount;
wherein in response to rotating the height adjustment mechanism, the drive rod turns and the bevel gear assembly activates to rotate the guide rod; the rotation of the guide rod is stopped when the motor is lowered to a position under the upper cutting surface to create a space between the motor and the upper cutting surface; and in response to unfastening the adjustment screw, the motor is configured to counterclockwise pivot about the pivot until the belt has a predetermined tautness;
wherein the motor is configured to clockwise rotate about the pivot to loosen the belt; and
wherein the guide rod is configured to push the mount upward to move along the first guide upright and the second guide upright.

2-3. (canceled)
